(19) United States
(12) Patent Application Publication
(10) Pub. No.: US 2020/0369876 A1
(43) Pub. Date: Nov. 26, 2020

(54) TRANSPARENT AND HEAT-RESISTANT POLYCARBONATE COMPOSITE AND PREPARATION METHOD THEREOF

(71) Applicant: Hangzhou Normal University, Hangzhou (CN)

(72) Inventors: Yongjin Li, Hangzhou (CN); Huihui Xu, Hangzhou (CN)

(21) Appl. No.: 16/857,735

(22) Filed: Apr. 24, 2020

(30) Foreign Application Priority Data
May 21, 2019 (CN) 201910421979.2

(51) Int. Cl. C08L 69/00; C08L 67/00; B29C 48/92; B29C 48/395; C08K 5/435

(52) U.S. Cl. CPC C08L 69/00; C08L 67/00; B29C 48/92; B29C 2948/92885; C08K 5/435; C08L 2201/10; B29C 2948/9258; B29C 48/397

(57) ABSTRACT

A transparent and heat-resistant polycarbonate (PC) composite and a preparation method thereof. The PC composite is a blend of a PC, a polyarylester (PAR) and an organic salt. The preparation method includes: drying the PC and the PAR each under vacuum at 80-120° C. for 24-48 h; adding the dried PC, the dried PAR and the organic salt into a melt blending device at a mass ratio of (60-90):(40-10):(0.3-3), and performing melt blending at 250-300° C. to obtain a mixture; and discharging the mixture from the melt blending device, and cooling to normal temperature to obtain a PC composite.

### RELATED CASE

This application claims priority to Chinese Application No. 201910421979.2, filed 21 May 2019, the entire contents of which are incorporated herein by reference.

### TECHNICAL FIELD

The present invention pertains to the technical field of polymer materials and relates to a polycarbonate (PC) composite having high transparency and heat resistance as well as a preparation method thereof, and in particular to a heat-resistant and transparent PC composite obtained by modifying a PC with an organic salt and a preparation method thereof.

### BACKGROUND

Polycarbonate (PC) is an amorphous, odorless, non-toxic and transparent thermoplastic polymer and the only transparent plastic. PC has desirable mechanical strength, heat resistance, ultraviolet (UV) radiation resistance, electrical resistance, high impact strength, small creep, and stable product size. It is easy to reinforce, non-toxic, hygienic and easy to stain. It has optimal cost performance and the potential for chemical modification and physical modification, and is an important engineering plastic with extremely wide applications. As an important engineering plastic, PC occupies an important position in the world plastic market. In 1988, the first article on the PC condensation compound was published. In 1953, Bayer AG developed the PC with high thermoplasticity and high melting point, and applied for the first PC patent in the same year. In 1958, Bayer AG achieved the industrial production of PC.

At present, PC is mainly applied in the following industries: 1) Construction. Because of good light transmittance, impact resistance, UV radiation resistance, stable product size and good formability, PC has prominent technical performance advantages over the inorganic glass conventionally used in the construction industry. PC occupies a dominant position in the world's construction industry, and about one-third of the PC is used for glass products such as window glass and commercial display windows. 2) Automobile manufacturing. PC is mainly used in the manufacture of lighting systems, instrument panels, heating plates, defrosters and bumpers, etc. PC is particularly used in the manufacture of automotive windows, automotive headlights, and thin-layer roofs (such as the fully transparent body eXasis first developed by Bayer AG). At present, many famous cars in the world such as Nissan, Ford, Mercedes-Benz and Volvo adopt optical PC materials for the production of automotive lampshade. 3) Aviation and aerospace. In this field, PC was originally used only for the manufacture of canopies and windshields for aircraft. The development of aviation and aerospace technology imposes higher requirements for various components in aircraft and spacecraft, making the applications of PC increasing in this field. As many as 2,500 PC parts are used on a single Boeing 747 aircraft, and nearly 2 t of PC are consumed by a single aircraft. On the spacecraft, hundreds of different configurations of PC parts and astronaut protective gear reinforced with glass fiber are used. 4) Electronic appliances. PC is mainly used in the production of various food processing machinery, power tool housings, bodies, stands, refrigerator drawers and vacuum cleaner parts, etc. PC has also shown a high value for important high-precision parts required in computers, video recorders and color televisions. 5) Optical lenses. Optical lenses made of optical grade PC has found broad applications ranging from cameras, microscopes, telescopes and optical test instruments to film projector lenses, copier lenses, infrared autofocus projector lenses, laser beam printer lenses, prisms and polygon mirrors, etc. PC has another important application as a lens material for children's glasses, sunglasses, safety glasses and adult glasses. 6) Disc substrate. PC is widely used as a disc substrate in the world. It can be used to prepare recordable compact discs such as compact discs (CDs), video compact discs (VCDs) and digital video discs (DVDs). In addition, PC has shown excellent properties in the formation of copolymer by grafting with styrene. 7) Packaging.

It is worth noting that there are two considerations in the above applications of PC, that is, the transparency and heat resistance of PC. For example, window glass in the construction industry, commercial display windows, automobiles and optical lenses all have requirements for transparency.

Polyarylester (PAR), also known as aromatic polyester, is a thermoplastic special engineering plastic with an aromatic ring and an ester bond on the main chain of the molecule. It is an amorphous, transparent polymer and a higher-grade engineering plastic with a similar structure to PC. Because the main chain contains a large number of aromatic rings, PAR has excellent heat resistance and good mechanical properties, and has a wide range of applications in the aviation, aerospace, electronics, automotive industry, machinery industry, medical supplies and daily necessities, etc. Although PAR has desirable heat resistance, it also has some disadvantages, such as high melt viscosity, poor fluidity, poor solubility and processing properties. Especially, it is difficult to produce thin-walled and large-sized products with PAR.

### SUMMARY

In order to solve the above problems, a large number of experiments have been made, and an innovative solution is thereby proposed to improve the heat resistance of PC and the partial miscibility between PC and PAR so as to obtain a transparent composite. Li-TFSI was used to compound and modify PC/PAR, and it was found that Li-TFSI promoted the transesterification of PC and PAR and thereby improved the miscibility and transparency of the materials.

An objective of the present invention is to provide a polycarbonate (PC) composite with high transparency and heat resistance. This material has excellent light transmittance and desirable heat resistance.

An objective of the present invention is achieved by the following technical solutions.

A transparent and heat-resistant PC composite is disclosed, where this material is a blend of a PC, a polyarylester (PAR) and an organic salt; a mass ratio of the PC, the PAR and the organic salt is (60-90):(40-10):(0.3-3), preferably 60:40:0.5.

The organic salt has a metal cation, specifically a lithium ion, a calcium ion, a magnesium ion or other metal cations.

The organic salt has an anion of (CF₃SO₂)₂N⁻, PF₆⁻, BF₄⁻, Br⁻, Cl⁻, I⁻, NO₃⁻ or CF₃CO²⁻.

Preferably, in the above technical solution, the organic salt is lithium bis(trifluoromethanesulfonyl)imide (Li-TFSI).

Another objective of the present invention is to provide a method for preparing the transparent and heat-resistant PC composite, specifically including the following steps:

step (1): drying the PC and the PAR each under vacuum at 80-120° C. for 24-48 h;

step (2): adding the dried PC, the dried PAR and the organic salt into a melt blending device at a mass ratio of (60-90):(10-40):(0.3-3), and performing melt blending at 250-300° C. to obtain a mixture;

where, the melt blending device is an internal mixer or a single screw extruder;

for example, adding the dried PC, the dried PAR and the organic salt into the internal mixer for melt blending, the rotor speed of the internal mixer being 40-60 rpm/min during blending, and the melt blending time being 3-10 min;

for example, adding the dried PC, the dried PAR and the organic salt into the single screw extruder for melt blending, the screw speed of the screw extruder being 15-20 rpm/min during feeding and 45-75 rpm/min during extrusion; and

step (3): discharging the mixture from the melt blending device, and cooling to normal temperature to obtain a PC composite with high light transmittance.

Preferably, in step (2), the dried PC, the dried PAR and the organic salt are added into the melt blending device for melt blending at a mass ratio of 60:40:0.5.

The present invention has the following beneficial effects:

The present invention innovatively adds the organic salt (preferably Li-TFSI) into the PC/PAR composite. (1) The operation is simple, and only small usage can make the immiscible PC/PAR system miscible to obtain the transparent material. This method has never been reported before. (2) The addition of the organic salt (preferably Li-TFSI) greatly improves the heat resistance of the PC blend, which satisfies the actual needs. The present invention only needs to use a commonly used melt blending device, and the industrial preparation is simple.

The present invention innovatively uses the organic salt (preferably Li-TFSI) and successfully modifies the PC/PAR composite. The addition of the organic salt improves the miscibility between the PC and the PAR, greatly improves the light transmittance of the material, and improves the heat resistance of the PC composite while ensuring certain mechanical properties of the material.

The PC composite of the present invention greatly improves the transparency of the blend, greatly improves the heat resistance and thermal stability of the PC, and can be applied to the automotive industry, construction, electronics and other fields.

### BRIEF DESCRIPTION OF DRAWINGS

FIG. 1 is a dynamic thermal analysis (DTA) diagram of a material prepared in Comparative Example 1 and Example 2-1;

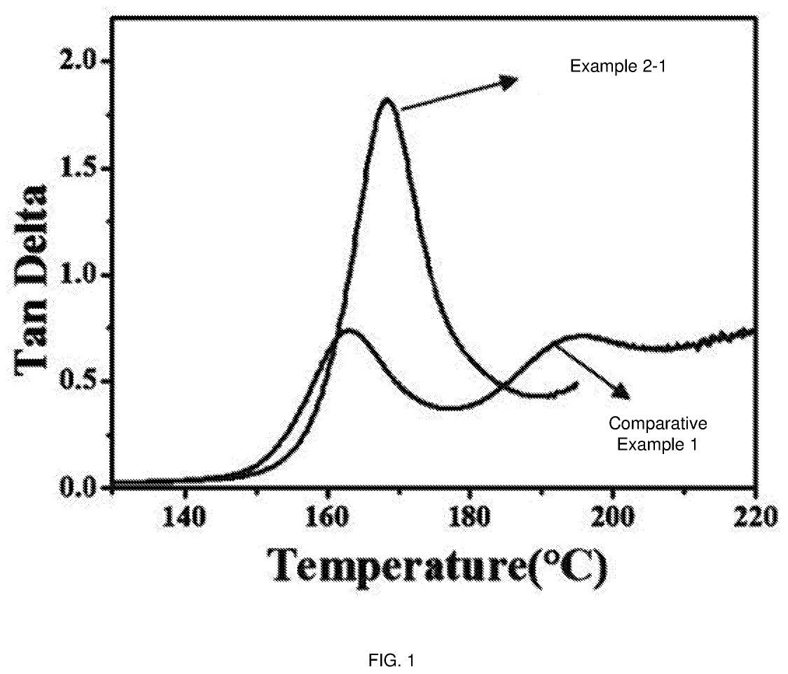

FIG. 2 is a thermogravimetric analysis (TGA) diagram of a material prepared in Comparative Example 1 and Example 2-1 under a nitrogen atmosphere; and

FIG. 3 is a differential thermogravimetric analysis (DTGA) diagram of a material prepared in Comparative Example 1 and Example 2-1.

### DETAILED DESCRIPTION

The present invention is further analyzed below with reference to the accompanying drawings and specific examples.

### COMPARATIVE EXAMPLE 1

Step (1): dry a polycarbonate (PC) and a polyarylester (PAR) each under vacuum at 120° C. for 24 h.

Step (2): add 36 g of dried PC and 24 g of dried PAR into an internal mixer, and perform melt blending for 10 min at 260° C. and 50 rpm/min.

Step (3): discharge a mixture from the melt blending device, and cool to normal temperature to obtain a PC/PAR composite.

A mass ratio of the PC to the PAR in the PC composite prepared in Comparative Example 1 is 60:40.

### EXAMPLE 2-1

Step (1): dry a PC and a PAR each under vacuum at 120° C. for 24 h, where Li-TFSI does not need drying.

Step (2): add 36 g of dried PC, 24 g of dried PAR and 0.3 g of Li-TFSI into an internal mixer, and perform melt blending for 10 min at 260° C. and 50 rpm/min.

Step (3): discharge a mixture from the melt blending device, and cool to normal temperature to obtain a PC composite.

A mass ratio of the PC, the PAR and the Li-TFSI in the PC composite prepared in Example 2-1 is 60:40:0.5.

The thermal performance of the materials prepared in Comparative Example 1 and Example 2-1 was tested.

The light transmittance and haze of the materials prepared in Comparative Example 1 and Example 2-1 were tested by pressing a sample into a 0.3 mm sheet.

Table 1 Glass transition temperature of materials prepared in Comparative Example 1 and Example 2-1

| Sample | | T_{g}(° C) | |
|---|---|---|---|
| Comparative Example 1 | 163.3 | | 196.7 |
| Example 2-1 | | 168.2 | |

Table 2 Light transmittance of materials prepared in Comparative Example 1 and Example 2-1

| Sample | Light transmittance (%) | Haze (%) |
|---|---|---|
| Comparative Example 1 | 86.1 | 44.2 |
| Example 2-1 | 89.8 | 2.9 |

The thermal performance test results are shown in Table 1. According to Tables 1 and 2, the simply melt PC/PAR blend had poor miscibility. The material showed two glass transition temperatures and appeared as an opaque white material. After the Li-TFSI was added, the miscibility of the material was improved. The material showed only one glass transition temperature, and the material appeared as colorless and transparent. This proved that the addition of the Li-TFSI significantly improved the miscibility of the PC/PAR, greatly improved the transparency of the composite, and met the standards of light-transmitting materials required by the industry.

Table 3 Heat-resistance test results of materials prepared in Comparative Example 1 and Example 1-2 under nitrogen atmosphere

| Sample | T_{5%} (° C) | Tₘₐₓ (° C) |
|---|---|---|
| Comparative Example 1 | 410.8 | 447.2 |
| Example 2-1 | 421.2 | 486.3 |

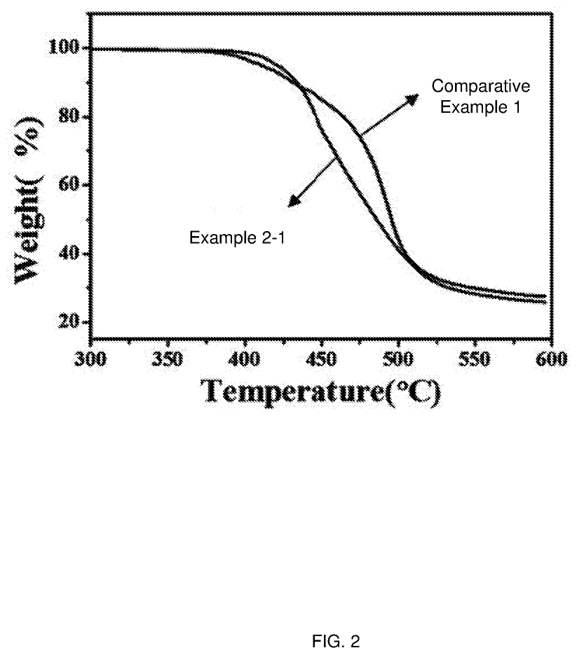

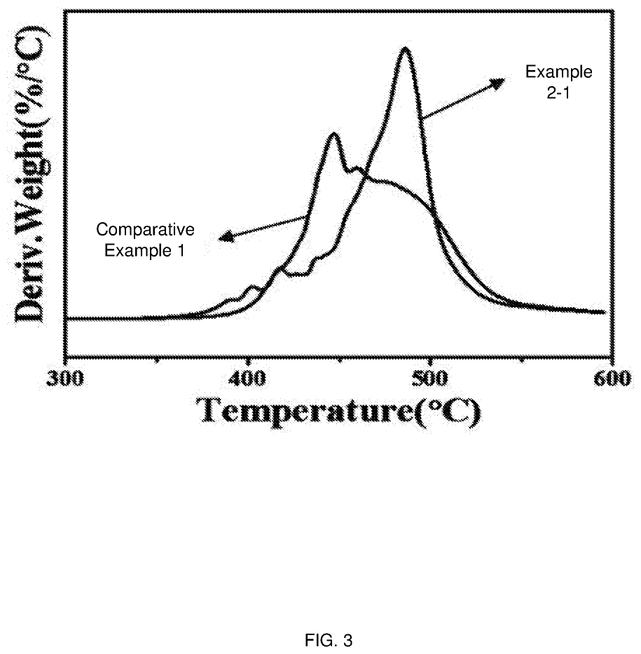

The heat resistance test results are shown in FIG. 2 and FIG. 3. The initial degradation temperature (T_{5%}) of the simply melt PC/PAR blend (Comparative Example 1) was 410.8° C., and the temperature corresponding to a maximum thermal weight loss (Tₘₐₓ) was 447.2° C., showing that the simply melt PC blend had a certain heat-resistant temperature. After the addition of the Li-TFSI, the T_{5%} of the blend increased by 10.4° C., and the Tₘₐₓ increased by 39.1° C., which proved that the addition of the Li-TFSI greatly improved the thermal stability and heat resistance of the PC blend.

### EXAMPLE 2-2

Step (1): dry a PC and a PAR each under vacuum at 120° C. for 24 h, where Li-TFSI does not need drying.

Step (2): add 42 g of dried PC, 18 g of dried PAR and 0.3 g of Li-TFSI into an internal mixer, and perform melt blending for 10 min at 260° C. and 50 rpm/min.

Step (3): discharge a mixture from the melt blending device, and cool to normal temperature to obtain a PC composite with high light transmittance.

A mass ratio of the PC, the PAR and the Li-TFSI in the PC composite prepared in Example 2-2 is 70:30:0.5.

### EXAMPLE 2-3

Step (1): dry a PC and a PAR each under vacuum at 120° C. for 24 h, where Li-TFSI does not need drying.

Step (2): add 48 g of dried PC, 16 g of dried PAR and 0.3 g of Li-TFSI into an internal mixer, and perform melt blending for 10 min at 250° C. and 40 rpm/min.

Step (3): discharge a mixture from the melt blending device, and cool to normal temperature to obtain a PC composite with high light transmittance.

A mass ratio of the PC, the PAR and the Li-TFSI in the PC composite prepared in Example 2-3 is 80:20:0.5.

### EXAMPLE 2-4

Step (1): dry a PC and a PAR each under vacuum at 120° C. for 24 h, where Li-TFSI does not need drying.

Step (2): add 54 g of dried PC, 6 g of dried PAR and 0.3 g of Li-TFSI into an internal mixer, and perform melt blending for 3 min at 260° C. and 60 rpm/min.

Step (3): discharge a mixture from the melt blending device, and cool to normal temperature to obtain a PC composite with high light transmittance.

A mass ratio of the PC, the PAR and the Li-TFSI in the PC composite prepared in Example 2-4 is 90:10:0.5.

### EXAMPLE 2-5

Step (1): dry a PC and a PAR each under vacuum at 120° C. for 24 h, where Li-TFSI does not need drying.

Step (2): add 36 g of dried PC, 24 g of dried PAR and 0.18 g of Li-TFSI into an internal mixer, and perform melt blending for 10 min at 300° C. and 50 rpm/min.

Step (3): discharge a mixture from the melt blending device, and cool to normal temperature to obtain a PC composite with high light transmittance.

A mass ratio of the PC, the PAR and the Li-TFSI in the PC composite prepared in Example 2-5 is 60:40:0.3.

### EXAMPLE 2-6

Step (1): dry a PC and a PAR each under vacuum at 100° C. for 48 h, where Li-TFSI does not need drying.

Step (2): add 36 g of dried PC, 24 g of dried PAR and 1.8 g of Li-TFSI into a single screw extruder for melt blending at 280° C. to obtain a mixture, the screw speed of the screw extruder being 10 rpm/min during feeding and 45 rpm/min during extrusion; and

Step (3): discharge the mixture from the melt blending device, and cool to normal temperature to obtain a PC composite.

A mass ratio of the PC, the PAR and the Li-TFSI in the PC composite prepared in Example 2-6 is 60:40:3.

The above examples are not intended to limit the present invention, and various changes derived from these examples without creative efforts should fall within the protection scope.

What is claimed is:

1. A transparent and heat-resistant polycarbonate (PC) composite, comprising:
a blend of a PC, a polyarylester (PAR) and an organic salt, wherein a mass ratio of the PC, the PAR and the organic salt is (60-90):(40-10):(0.3-3).

2. The transparent and heat-resistant PC composite according to claim 1, wherein the organic salt has a metal cation.

3. The transparent and heat-resistant PC composite according to claim 1, wherein the organic salt has an anion of (CF₃SO₂)₂N⁻, PF₆⁻, BF₄⁻, Br⁻, Cl⁻, I⁻, NO₃⁻ or CF₃CO²⁻.

4. The transparent and heat-resistant PC composite according to claim 2, wherein the organic salt is lithium bis(trifluoromethanesulfonyl)imide (Li-TFSI).

5. The transparent and heat-resistant PC composite according to claim 3, wherein the organic salt is lithium bis(trifluoromethanesulfonyl)imide (Li-TFSI).

6. The transparent and heat-resistant PC composite according to claim 1, wherein a mass ratio of the PC, the PAR and the organic salt is 60:40:0.5.

7. A method for preparing a transparent and heat-resistant polycarbonate (PC) composite comprising a blend of a PC, a polyarylester (PAR) and an organic salt, the method comprising:
drying the PC and the PAR each under vacuum at 80-120° C. for 24-48 h;
adding the dried PC, the dried PAR and the organic salt into a melt blending device at a mass ratio of (60-90):(10-40):(0.3-3), and performing melt blending at 250-300° C. to obtain a mixture; and
discharging the mixture from the melt blending device, and cooling to normal temperature to obtain a PC composite.

8. The method according to claim 7, wherein the organic salt has a metal cation.

9. The method according to claim 7, wherein the organic salt has an anion of (CF₃SO₂)₂N⁻, PF₆⁻, BF₄⁻, Br⁻, Cl⁻, I⁻, NO₃⁻ or CF₃CO²⁻.

10. The method according to claim 8, wherein the organic salt is lithium bis(trifluoromethanesulfonyl)imide (Li-TFSI).

11. The method according to claim 9, wherein the organic salt is lithium bis(trifluoromethanesulfonyl)imide (Li-TFSI).

12. The method according to claim 7, wherein a mass ratio of the PC, the PAR and the organic salt is 60:40:0.5.

13. The method according to claim 7, wherein the melt blending device is an internal mixer; the rotor speed of the internal mixer is 40-60 rpm/min during blending, and the melt blending time is 3-10 min.

14. The method according to claim 7, wherein the melt blending device is a single screw extruder; the screw speed of the screw extruder is 15-20 rpm/min during feeding and 45-75 rpm/min during extrusion.
